(19) United States
(12) Patent Application Publication
(10) Pub. No.: US 2023/0373804 A1
(43) Pub. Date: Nov. 23, 2023

(54) Flow-Assisted Selective Mineral Extraction from Non-Traditional Sources

(71) Applicant: BATTELLE MEMORIAL INSTITUTE, Richland, WA (US)

(72) Inventors: Chinmayee Subban, Seattle, WA (US); Qingpu Wang, Seattle, WA (US); Elias Nakouzi, Richland, WA (US)

(73) Assignee: BATTELLE MEMORIAL INSTITUTE, Richland, WA (US)

(21) Appl. No.: 18/318,573

(22) Filed: May 16, 2023

Related U.S. Application Data
(60) Provisional application No. 63/342,901, filed on May 17, 2022.

(51) Int. Cl. C01F 5/22

(52) U.S. Cl. CPC C01F 5/22; C01P 2006/80; C01P 2002/72

(57) ABSTRACT

Laminar co-flow methods for the extraction and separation of highly pure Mg(OH)₂ and other minerals from complex ionic mixtures by precipitation are disclosed herein. Mineral precipitates prepared according to methods disclosed herein demonstrated exceptional purity, and faster separation compared to conventional bulk methods. LCM mineral extractions were driven by non-equilibrium concentration gradients present at the interface between source and reactant solutions, allowing the methods to operate practically on industrial scale.

### REFERENCE TO RELATED APPLICATIONS

This application claims the benefit of U.S. Provisional Application No. 63/342,901 filed on May 17, 2022, the disclosure of which is incorporated herein by reference in its entirety.

### STATEMENT OF GOVERNMENT INTEREST

This invention was made with government support under Contract DE-AC0576RL01830 awarded by the U.S. Department of Energy. The government has certain rights in the invention.

### BACKGROUND

Material production is responsible for over half of all the global greenhouse gas emissions. One approach to minimizing these emissions is reducing reliance on materials produced using carbon-intensive energy sourcing, and instead using clean energy powered mining of primary feedstock minerals from abundant sources. Seawater, geothermal brines, and industrial wastes are abundant and mineral rich, for example, and are also more abundant and geographically dispersed than mineral deposits. However, selectively extracting minerals and elements of interest and commercial value from such non-traditional sources can be challenging, as these sources often contain variable and complex mixtures of ions.

From a thermodynamics standpoint, chemical separations require successfully overcoming the entropic driving force for mixing. Certain conventional approaches have perturbed complex mixtures away from their equilibrium mixed state by applying electric fields as in electrodialysis. Other approaches may introduce a new type of interaction by using adsorbents that bind favorably to specific components in the mixture. Conventional methods can include pre-concentration/selection (e.g., ion-exchange, selective catalysts) and post-treatment (e.g., dissolving impurities) which are energy and cost intensive and also may be environmentally harmful. While conventional methods have found utility in a variety of applications, they remain beset by technical limitations such as the ineffective separation of similarly charged ions, limited durability of membranes and adsorbents, or the energy-input necessary for sustaining non-equilibrium conditions and driving towards separation.

Production of magnesium hydroxide (Mg(OH)₂) provides a commercially significant example. In the early 1940s, magnesium (Mg) metal was produced by electrolysis in the U.S. starting from seawater-sourced Mg(OH)₂. However, global production of Mg and related compounds has been largely limited to China, where it is obtained primarily from mined dolomite. Given the growing importance of Mg compounds for sustainability-related applications (low-carbon cement, vehicle light weighting, carbon capture, etc.), and the demonstrated feasibility of sourcing Mg from seawater at-scale, a resurgence of distributed seawater-sourced Mg production remains of interest. Mg is on the critical minerals and materials list recently published by the U.S. Department of Energy.

Generally, seawater-based Mg extraction involves adding one or more precipitants to obtain Mg(OH)₂, but the co-existence of Ca²⁺ unavoidably results in impurities. Alternate approaches for Mg metal from seawater rely on electrochemical techniques that are slow and energy intensive, such as via the Pidgeon process. Further, such processes generate large quantities of byproducts such as chlorine, calcium chloride and sodium chloride and ferrous and ferric chloride that must be utilized or disposed of Most current Mg processing methods are so energy intensive that significant investments have been made to improve process efficiency and lower cost.

Therefore, there exists a need for a simple, efficient, and low-cost method to selectively separate elements of interest from complex and dilute sources, with high yield and purity.

### SUMMARY

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

The present disclosure relates to separation methods that leverage non-equilibrium conditions in a flow cell and can generate phase-pure solid precipitates of minerals, or chemical compounds, from complex mixtures of dissolved salts. Methods disclosed herein can rely on differences in solubility constants to selectively separate minerals from both aqueous ion mixtures (e.g., seawater), and non-aqueous ion mixtures. In certain aspects, methods may be used to extract minerals deemed critical by the Department of Energy (DOE) for domestic supply of essential materials, or for particular industries, by selecting an appropriate reactant to flow along with a mineral source.

In certain embodiments of laminar co-flow methods for chemical extraction disclosed herein, the method can comprise flowing a mineral source solution through a first flow path of a flow cell chamber, flowing a reactant solution through a second flow path of the flow cell chamber, and contacting the mineral source solution and the reactant solution along a flow path interface to form a mineral precipitate at the flow path interface. In certain aspects, the mineral precipitate can comprise a cation from the mineral source solution and an anion from the reactant solution. In another aspect, the mineral precipitate can comprise an anion from the mineral source solution and a cation from the reactant solution.

Flow cells are also disclosed herein configured to carry out laminar co-flow methods. In certain aspects, methods can be performed using flow cells comprising a plurality of inlets leading to a common flow chamber, wherein the flow chamber comprises a first flow path and a second flow path which converge to form a flow path interface. In certain aspects, the flow chamber can comprise a tubular cavity configured to receive a flow from each of the plurality of inlets (e.g., via a Y-shaped intersection) and contact each flow along a flow path interface extending in the direction of the laminar flow. In certain aspects, the flow cell can further comprise an outlet for the flow to exit the flow cell. In certain aspects, the flow cell can comprise a plurality of outlets, each of the plurality of outlets associated with a flow path through the flow cell route the respective solutions to exit the flow chamber separately where they can be directed toward waste, reuse, or recycling.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an embodiment of a flow cell.

FIG. 2 is a schematic view of a contacting interface usable in the flow cell of FIG. 1.

FIG. 3 is a reactant concentration graph across the flow cell of FIG. 1.

FIG. 4. is an illustration of the flow cell of FIG. 1. highlighting the region where Mg(OH)₂ is precipitated.

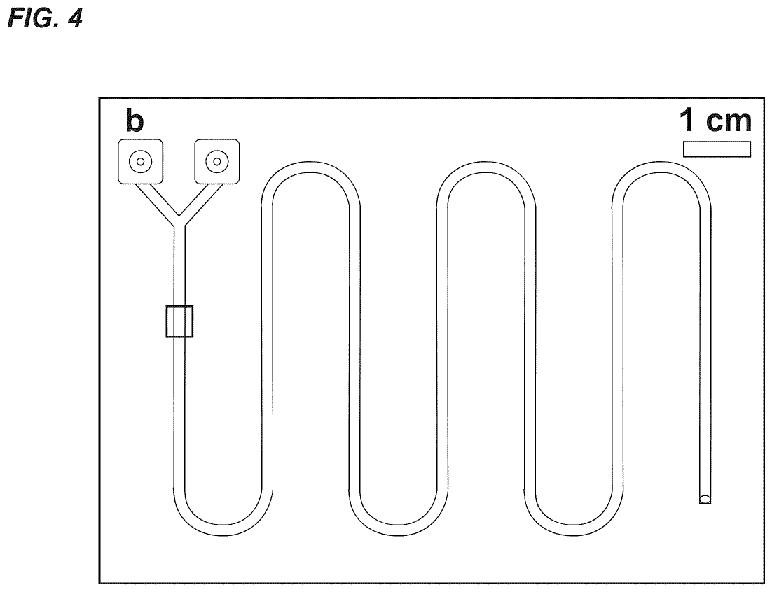

FIG. 5 is a micrograph image of the formed precipitate of FIG. 3 in brightfield illumination.

FIG. 6 illustrates x-ray diffraction patterns of the precipitate formed in FIG. 3, as compared to a bulk mixing method.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

While compositions and methods are described herein in terms of “comprising” various components or steps, the compositions and methods also can “consist essentially of” or “consist of” the various components or steps, unless stated otherwise. For example, a catalyst composition consistent with aspects of the present invention can comprise; alternatively, can consist essentially of; or alternatively, can consist of; a metallocene compound, a co-catalyst, and a sulfated bentonite composition.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

For any particular formula or name that is presented, any general formula or name presented also encompasses all conformational isomers, regioisomers, and stereoisomers that can arise from a particular set of substituents.

The terms “contacting” are used herein to describe compositions, processes, and methods in which the materials or components are combined together in any order, in any manner, and for any length of time, unless otherwise specified. For example, the materials or components can be blended, mixed, slurried, dissolved, reacted, treated, compounded, or otherwise contacted or combined in some other manner or by any suitable method or technique.

As used herein, the term “mineral” can refer generally to any ion-containing chemical compound or species capable of being isolated by processes disclosed herein. Generally, minerals referred to herein can comprise an organic salt or inorganic salt, e.g., compounds comprising both a cationic species and an anionic species. In certain aspects, the term “mineral” may refer to either of the cation or anion independently, or alternatively, a particular cation generically paired with any suitable anion that may be available. The use of the term “mineral” is therefore not intended to be limited by the nature of a particular chemical's typical origin (e.g., compounds obtained by mining).

Laminar and turbulent flow are referred to herein. Laminar flow generally refers to fluids traveling in smooth and regular paths, with little or no turbulent mixing between adjacent layers. This type of flow is characterized by a low Reynolds number. Most flows are neither purely laminar nor purely turbulent, but a Reynolds number of less than about 2300 is generally considered to be laminar, where the Reynolds number R is defined using the density (ρ), the characteristic velocity (v), the characteristic length scale (L), and the dynamic velocity (μ) as

R=ρvL/μ.

With respect to laminar flow and other physical phenomena, the terms “substantially” or “about” may be used to refer to terms of degree. For example, a substantially laminar flow need not be purely laminar, and should be expected to have some consistence. Dimensions, rates, and other measurable quantities should be understood to be approximate as determined by machining tolerances, manufacturing variability, measurement limitations, and the like. A “high-purity” material as described herein should be understood to refer to a purity greater than typical, conventional purity for that material, which could be greater than 90%, 95%, or 99%, or even higher depending upon the material being obtained.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, when a flow rate within a certain range is disclosed or claimed, the intent is to disclose or claim individually every possible number that such a range could encompass, consistent with the disclosure herein. For example, the disclosure that a flow rate is in a range from 0.1 mL/h to 10 mL/h, as used herein, refers to a flow rate of 1 mL/h, 2 mL/h, 3 mL/h, 4 mL/h, 5 mL/h, 6 mL/h, 7 mL/h, 8 mL/h, 9 mL/h, or 10 mL/h, as well as any range between these two numbers (for example, from 1 mL/h to 2 mL/h).

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

### DETAILED DESCRIPTION

The present disclosure relates to separation techniques that leverage non-equilibrium conditions in a flow cell to generate phase-pure solid precipitates. Without being bound by theory, methods disclosed herein may rely on differences in solubility to selectively separate minerals from an aqueous ion mixture (e.g., seawater). Methods disclosed herein may be used to extract various minerals deemed critical by the Department of Energy (DOE), by simply selecting an appropriate reactant to flow along with source water.

The information that follows describes embodiments with reference to the accompanying figures, however, may be embodied in many different forms and should not be construed as limited to the illustrated embodiments set forth herein.

Laminar co-flow methods for chemical extraction are disclosed herein that facilitate the formation of substantially phase-pure forms of precipitate minerals from complex ionic solutions comprising a mixture of ions. Generally, the methods can comprise forming a flow path interface between two solutions flowing together, such that anions from a reactant solution are able to pass across a concentration gradient defined by the flow path interface and into the material source solution. Upon the anion flowing into the material source solution, the mineral may selectively precipitate to generate a solid layer of a high purity mineral as a crystalline form. In certain aspects, the mineral precipitate may be washed to remove surface attached ions and residual solutions, collected from the flow cell in which the precipitate formed, and dried to yield an exceedingly pure mineral.

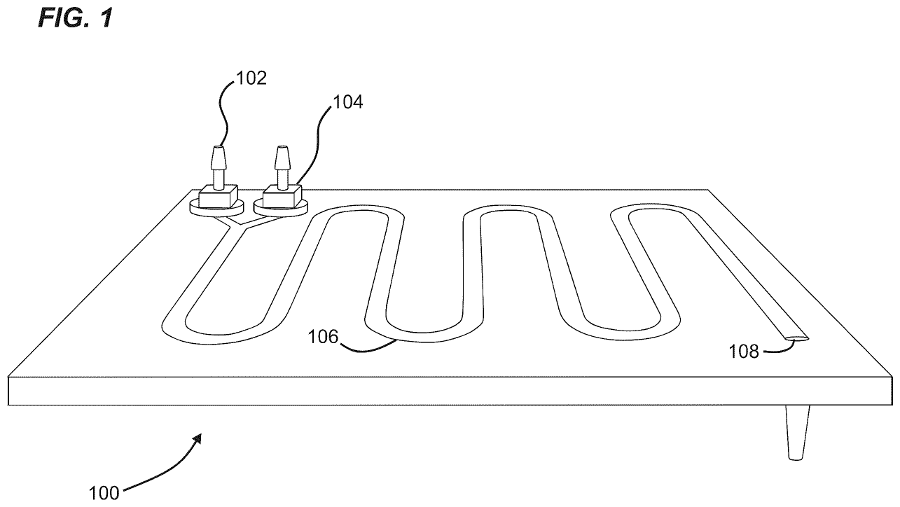

FIG. 1 provides an illustration of a Y-shaped flow cell that was used for examples disclosed herein. As shown in FIG. 1, flow cell 100 comprises a mineral source inlet 102 and a reactant inlet 104. Inlets 102 and 104 each comprise a connector configured to mate with a syringe or tubing to receive respective solutions, and ultimately pass those solutions into the flow chamber. Once in the flow chamber 106, the solutions can contact one another as described in more detail below, with respect to flow chamber 106. Each flow path leading from inlets 102 and 104 converges in a Y-shaped intersection to form the flow chamber 106 within which the mineral precipitation occurs. Flow cell 100 further comprises a single outflow port 108 at the end of flow chamber 106, which may be directed to waste, recycle, or subsequent processing (e.g., extraction of a second mineral from the mineral source solution).

Flow chamber 106 is serpentine along its length with a rectangular cross-section. However, the flow chamber within the flow cell is not limited to any orientation or shape. The flow chamber within the flow cell can be in any orientation or any shape that brings the separately received solutions together in a substantially laminar flow, with a flow path interface between the flow paths of the mineral source and reactant solutions. In certain aspects, the flow chamber can have a circular cross-section, a square cross-section, or an oval cross-section. In certain aspects, the flow chamber can be linear along its length.

The size of the flow chamber may similarly be any that is suitable to maintain a laminar co-flow of the mineral source solution and the reactant solution. In certain aspects, the volume of the flow chamber can be relatively small, for instance in a range from 10 μL to 10 mL. In other aspects, the flow chamber can be relatively large, for instance in a range from 1 L to 100 L. It is also contemplated herein that the flow chamber may be constructed as a loop such that the mineral source solution may be recycled and replenished on successive passes of each through the flow chamber. In such aspects, it will be understood that the length of the flow chamber may be defined according to a residence time of either solution within the flow chamber, further dependent on the flow rate of each solution. In certain aspects, the flow rate can be in a range from 0.1 mL/h to 100 L/min, from 0.1 mL/h to 10 L/h, or any intermediate rate within those ranges. In another aspect, the flow rather may be larger if an industrial scale separation is used, for example, from 100 L/h to 300 L/h. The flow rate of the mineral source solution can be the same or different than the flow rate of the reactant solution. In certain aspects a ratio of the flow rate of the mineral source to the reactant solution can be in a range from 10:1 to 1:10, from 5:1 to 1:5, or from 2:1 to 1:2.

Accordingly, it is contemplated that the examples disclosed herein may readily be applied to industrial scale separations because LCM is based on non-equilibrium flow. For example, LCM systems can comprise a plurality of microreactors or adopt alternate channel geometries that correspond to higher throughput, or a combination of both may be used.

Under laminar co-flow conditions, a concentration gradient can be maintained at the flow path interface between the mineral source solution and the reactant solution. Initially, the flow path interface is maintained without a solid physical border. Minimal turbulence within the flow chamber, as characterized by its Reynolds number, can ultimately stabilize the flow path interface and promote the formation of mineral precipitate. In certain aspects, the combined flows of the mineral source solution and the reactant solution can have a Reynolds number less than 2,500, less than 1,000, less than 500, less than 100, less than 50, less than 10, less than 5, or less than 1. In other aspects, the Reynolds number can be in a range from 0.1 to 1,000, from 0.1 to 250, or from 0.1 to 100.

The arrangement of the inlets and outlets with respect to the surfaces of the flow cell also is not limited, and can be any that are suitable and convenient to maintain laminar flow of each solution through the flow chamber. For instance, as shown in FIG. 1, one or more inlets 102, 104 may be located on a first side of the flow cell, and one or more outflow ports 108 may be located on a second side of the flow cell. In certain aspects, the outflow ports may be located on the second side of the flow cell for the purpose of avoiding undesired precipitate accumulation and clogs.

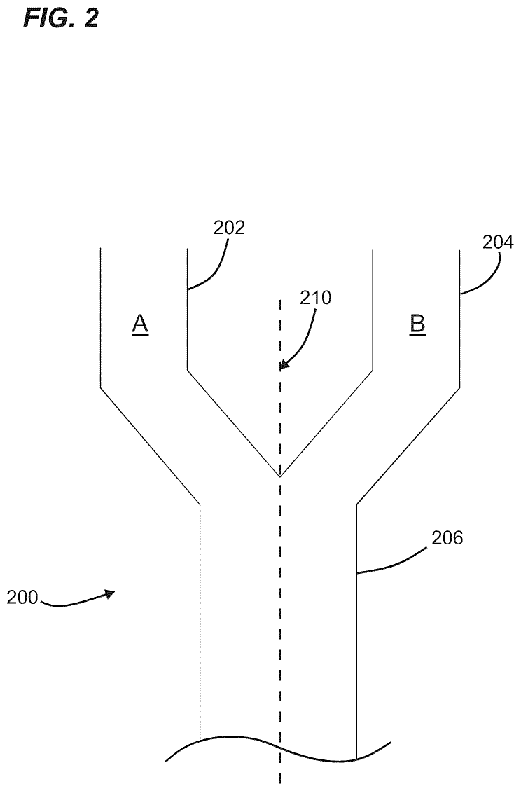

Referring now to FIG. 2, a simplified detailed view of a flow cell 200 is shown. Flow cell 200 includes a first inlet 202 and a second inlet 204 carrying reactants A and B, respectively. The reactants A and B contact one another in flow chamber 206, in a laminar co-flow environment, and interact with one another at contacting interface 210.

In the simplified system shown in FIG. 2, the contacting interface 210 is a line passing roughly through the center of the flow chamber 206. In other versions, such as those in which the flow rate for reactant A or B is larger than the other, the contacting interface 210 may be positioned closer to one side or the other.

Reactants A and B contact one another at the contacting interface 210 and form precipitate. Further, because reactants A and B contact one another in a laminar co-flow environment, the reactants A and B are relatively stationary to one another, even while they are moving with respect to the surrounding flow chamber 206. The reactants A and B will therefore form precipitates in a stable environment in which crystal growth is not substantially disturbed by turbulence. Precipitate can therefore be formed relatively quickly as the reactants A and B travel through the flow chamber 206.

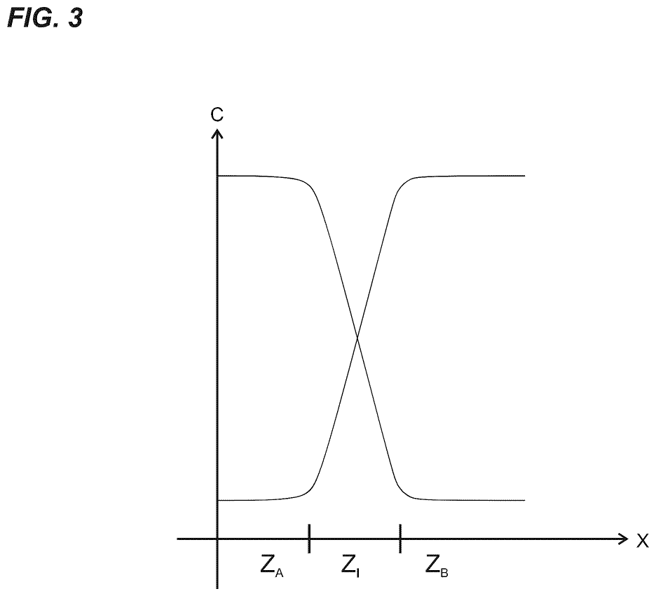

Of course, there are a multitude of arrangements that can introduce the reactants A and B to one another without substantial turbulence. One such alternative is shown in FIG. 3.

FIG. 3 shows a schematic of reactant concentration (C_{A}, C_{B}) of reactants A and B, respectively, as a function of horizontal distance (x) across flow chamber 106 of FIG. 1. Zone Z_{A} is a region in which the reactant A predominates, while zone Z_{B} is a region in which the reactant B predominates. The contacting interface zone Z_{I} is positioned between zones Z_{A} and Z_{B} and in this region the concentrations of the reactants are changing as a function of the x position.

As shown in FIG. 3, the contacting interface zone Z_{I} may have a width defined by the concentration gradient formed between the two solutions flowed through the flow chamber. In certain aspects, the width of the contacting interface zone Z_{I} may be defined nominally, for instance, in a range from 0.01 mm to 10 cm, from 0.1 mm to 1 cm, or from 1 mm to 1 cm. In other aspects, the width of the flow path interface may be defined relative to other features of the flow chamber or to the flow itself. For instance, in certain aspects, the width of contacting interface zone Z_{I} can be less than 5%, less than 10%, or less than 25% the width of the flow chamber (e.g., the widest cross-section of the flow chamber).

In addition to the flow characteristics described above, flowing the mineral source and/or the reactant solution through flow paths of the flow cell chamber can comprise any conditions (e.g., temperature, pressure) that are suitable to facilitate formation of the mineral precipitate. A temperature gradient may be used, where a cooler flow path is present on one side of the flow cell chamber, and a warmer flow path on the other side of the flow chamber, leading to precipitation in the middle. In another aspect, the temperature gradient may be along the flow cell chamber to sequentially extract different minerals.

For example, the flow chamber can be kept at a temperature of 25° C., or in a range from 0° C. to below the boiling point of the solvent, and at atmospheric pressure during formation of a precipitate. Although not depicted herein, additional components can be used such as pumps, vacuums, heaters, or chillers that maintain a desired temperature and pressure environments in the systems described herein, and in particular at the laminar co-flow region.

The mineral source solution may be any that comprises a desired mineral, that is generally available in abundance and accessible for use. In certain aspects, the mineral source solution may be a natural source, such as seawater or geothermal brine. In other aspects, the mineral source solution can be an industrial or manufactured source, such as by-products from industrial chemical processes or recycling streams. In another embodiment, a mixture other than an aqueous ion mixture may be used. For example, organic flow solutions having a different viscosity of materials may be used as the reactant solution in methods disclosed herein.

In one embodiment, the present disclosure uses a Y-shaped flow-cell to facilitate a first flow path, and a second flow path running parallel, or adjacent to one and other and converging at an interface. The first flow path and the second flow path may house a source solution, and a reactant solution, respectively. At the interface of the Y-shaped flow cell, the first flow path and the second flow path facilitate the formation of a precipitate that may be extracted. The method of the present disclosure allows for added selectivity, and increased reliability in extracting a specific mineral, when compared with bulk mixing methods (i.e., two solutions mixed in a beaker to form a precipitate).

Methods disclosed herein can be tailored to extraction of various minerals and mineral mixtures from a variety of non-traditional sources—seawater, industrial and geothermal brines among others. In certain embodiments, the mineral precipitate can comprise aluminum (bauxite), antimony, arsenic, barite, beryllium, bismuth, cesium, chromium, cobalt, fluorspar, gallium, germanium, graphite (natural), hafnium, helium, indium, lithium, magnesium, manganese, niobium, platinum group metals, potash, and the rare earth elements group, rhenium, rubidium, scandium, strontium, tantalum, tellurium, tin, titanium, tungsten, uranium, vanadium, and zirconium. Generally, these may be precipitated as salts including hydroxides, carbonates, sulfates, phosphates and the like. Accordingly, the mineral precipitate recovered from methods disclosed herein can comprise magnesium carbonate, magnesium hydroxide, magnesium phosphate, calcium carbonate, calcium phosphate, calcium sulfate, barium sulfate, aluminum phosphate, lithium phosphate, manganese hydroxide, calcium oxalate, or combinations thereof. In another embodiment, barite or BaSO₄, a DOE critical mineral may be extracted from seawater or geothermal brine using the method of the present disclosure, with Na₂SO₄ reactant. This approach may open up new mineral sources for domestic barium production.

Precipitation reactions may occur exclusively at the flow path interface between the two fluids, and the accumulative precipitate may create a wall within the flow path interface that extends along the length of the channel. The precipitate wall may thicken over time. Once the mineral precipitate has formed, the flow may be stopped, and the precipitate collected. In certain aspects, the solids formed may then be retrieved either with an “air-flush” or by cell disassembly and may have a lower chemical and energy footprint than conventional methods.

The mineral source solution can be any mineral containing source conventional mine leachates, recycling streams, or non-traditional sources (i.e., not the most concentrated mineral sources). For each source, the reactant chemical is likely to be different due to differences in competing ions/minerals. Generally, the reactant should selectively target the mineral of interest over competing species to create a precipitate.

In another embodiment, the substantially phase-pure forms of precipitates may form a sheet of high-purity material comprising the precipitate minerals. The sheet of high-purity material may refer to a thin and flat piece of a naturally occurring inorganic solid substance with a definite chemical composition and crystal structure. The high-purity mineral sheets may be characterized by their flat and layered structures, which result from the arrangement of mineral atoms in a repeating pattern.

In one embodiment, reactants A and B may travel through adjacent plena. Unlike the previously described embodiments, the reactants A and B are not both entirely routed into the same plenum. The region in which the reactants A and B interact is a contacting interface, which may run alongside a dividing wall between the plena. The flow patterns at boundaries differ from the central region of a fluid flow, and this embodiment may create laminar co-flow at different temperatures, pressures, and flow rates than the structure shown in FIG. 2.

Additionally, collecting the precipitate formed by the reaction of A and B in laminar co-flow conditions may be simplified in the embodiment described above. In one example, an outlet of the plenum could have a screen or other filter to separate solids from liquids, such that remaining reactant B is separated from precipitate formed at contacting interface. It could also be flowing an alternate solvent through the device to recover a concentrated stream of dissolved precipitate for recrystallization of subsequent extraction. In some embodiments, it could be an “air or gas” flush to dislodge the solid precipitate. In further embodiments, the precipitate may be collected by centrifugation, filtration, decantation, or another method.

In another embodiment, the Y-shaped flow cell may facilitate the separation of Neodymium and Dysprosium for recycling used magnets.

The present disclosure is further illustrated by the following examples, which are not to be construed in any way as imposing limitations to the scope of this invention. Various other aspects, embodiments, modifications, and equivalents thereof which, after reading the description herein, may suggest themselves to one of ordinary skill in the art without departing from the spirit of the present invention or the scope of the appended claims.

Materials and General Procedures

All solutions were prepared with ultrapure water filtered by a Milli-Q IQ 7000 water purification system (resistivity, 18.2 MΩ cm). Synthetic seawater was prepared as a solution of “Instant Ocean”, an artificial seawater manufactured by Aquarium Systems of Mentor, OH, at a concentration of 34 g/L in water. Natural seawater was collected from the collected from Sequim Bay and was filtered through a 40 μm filter before use. The pH values of all the solutions used in this study are listed in Table 1 below. The concentrations of major cations in synthetic and natural seawater samples are listed in Table 2 below.

Lateral co-flow experiments were performed on the flow cell depicted in FIG. 1 and laminar co-flow methods were performed as follows. The flow-cell was constructed using known microfluidic device methods. The cell may consist of a cut Parafilm membrane sandwiched between two polycarbonate plates (10 cm×8 cm×1.6 mm, each). The elongated Y-shaped pattern may have a thickness of approximately 0.13 mm. The flow cell may further comprise one rectangular shape with two 1.6 mm-diameter holes (for inlets) and one with a 2.4 mm-diameter hole (for outlet). The outflow port may be purposefully designed on the bottom plate to avoid undesired precipitate accumulation and clogs, as seen in FIG. 1. The resulting flow cell may have a serpentine-shaped channel with a width of approximately 1 mm to approximately 200 mm, a length of approximately 100 mm to approximately 1,000 mm, a height of approximately 0.1 mm to approximately 100 mm, and a volume of approximately 0.160 mL. The channel was filled with deionized water before use to avoid flow disruption from air bubbles in the channel.

Reactant solutions were delivered to the flow cell via the flow cell inlets using a syringe, one filled with either synthetic or natural seawater and another containing NaOH of the appropriate concentration were connected to the inlets of the flow cell pictured in FIG. 1 using plastic tubing. The solutions were co-injected into the flow cell at a constant flow rate of about 1.5 mL/h, typically for 2 h. After the injection, the flow cell was opened and a sample of the precipitate was collected and transferred to a 1.5 mL centrifuge tube. The collected sample was then centrifuged at 10,000 rpm for 3 minutes to separate the solid from the supernatant. The solid sample was washed twice with 1.5 mL of DI water to remove surface-attached ions and soluble salts. The sample was then washed with 1.5 mL ethanol to help the drying process under ambient conditions overnight.

In another embodiment, rather than opening the flow cell, the precipitate may be collected by various procedures, including and not limited to centrifugation, filtration, decantation, or another method of collection.

Precipitates obtained by each example were analyzed according to their composition, purity, and morphology.

Micrographs of the precipitate in the flow cell were collected using an optical microscope (Thermo Fisher Scientific, EVOS FL Auto). The mass of the dried precipitate was first measured using an analytical balance (Mettler Toledo, XSR105). Then the samples were manually ground using a mortar and pestle for further characterization. Powder X-ray diffraction (XRD) measurements were performed using a Bruker D8 Discover Microfocus diffractometer at an average scan rate 0.37 deg/s. The magnesium-to-calcium ratio in the digested precipitate was measured by inductively coupled plasma mass spectrometry (ICP-MS) using a Perkin Elmer NexION 2000. For scanning electron microscopy (SEM) a FEI Sirion XL30 and for energy dispersive X-ray spectroscopy (EDS) an Oxford Instruments system were used. All samples were coated with 10 nm carbon prior to SEM and EDS characterization.

TABLE 1
pH of Seawater Samples and NaOH Solutions

| Sample | pH |
|---|---|
| Synthetic seawater | 8.20 |
| Natural seawater from Sequim Bay | 7.71 |
| 0.1M NaOH | 12.91 |
| 0.2M NaOH | 13.14 |
| 0.5M NaOH | 13.45 |
| 1.0M NaOH | 13.86 |
| 2.0M NaOH | 13.97 |

The above table illustrates the pH of seawater samples and NaOH solutions that were used in the examples contained herein. The measurements of the samples provided were performed at 21° C.

TABLE 2
Catio Concentrations in the Natural Seawater, Synthetic
Seawater, and the Instant Ocean Sea Salt

| | Natural | Synthetic | Instant Ocean |
|---|---|---|---|
| | seawater | seawater¹ | Sea Salt² |
| | (mg/L) | (mg/L) | (mg/g) |
| Sodium (Na [symbol] ) | 8571 | 10454 | 10.62 |
| Magnesium (Mg [symbol] ) | 841 | 1256 | 1.26 |
| Calcium (Ca [symbol] ) | 323 | 400 | 0.38 |
| Strontium (Sr [symbol] ) | 7.5 | 7.5 | 0.02 |

[symbol]

indicates data missing or illegible when filed

The above table indicates the concentrations of the major cations present in the natural seawater sample, the synthetic seawater, and the Instant Ocean Seat Salt.

### Comparative Example 1: Precipitation of Mg(OH)₂ From Synthetic Seawater by Bulk Mixing Methodology (BMM)

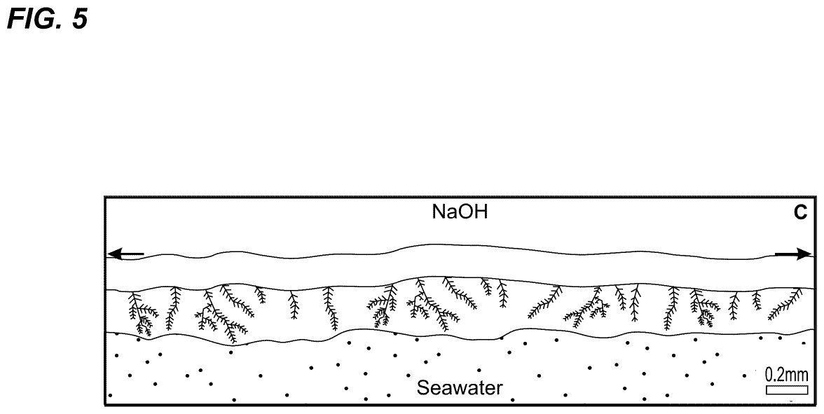

As a comparative example, a precipitate was also prepared according to a bulk mixing method (BMM) where 3 mL of 0.1M NaOH solution and 3 mL of synthetic seawater were added to a 20 mL glass vial and stirred for 1 hour at 500 rpm. The slurry product was centrifuged, and the solid was then washed and dried as described above for the laminar co-flow samples. The composition and purity of the resulting precipitate was determined by X-ray crystallography, shown relative to the precipitate obtained by Example 1 in FIG. 5. Unexpectedly, the XRD of the BMM precipitate contained peaks indicating the presence of significant amounts of aragonite (CaCO₃) relative to the LCM-prepared sample which was essentially pure Mg(OH)₂.

### EXAMPLE 1: Precipitation of Mg(OH)₂ From Synthetic Seawater by LCM

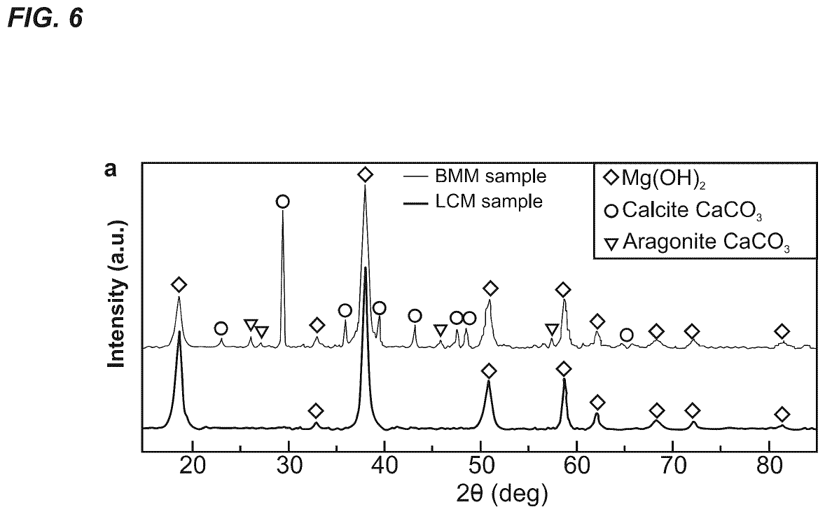

Example 1 was prepared as described above, by the co-injection of 0.1 M NaOH and synthetic seawater along the flow cell pictured in FIG. 1. A gel-like opaque layer formed within the first 15 minutes of the experiment, and stopped growing thereafter, while formation of a transparent layer continued throughout the 2 h experiment. Results of the experiment are shown in FIGS. 6 and 7. Referring to FIG. 6, an image of the resulting precipitate in the flow cell after 2-hour co-injection of 0.1 M NaOH (left) and synthetic seawater (right). Referring to FIG. 5, a micrograph of the formed precipitate in brightfield illumination, corresponding to the area highlighted by the red box in FIG. 6.

The precipitate was collected, washed and dried as above. After drying, it was observed that the opaque layer had shrunk significantly, indicating that the precipitated Mg(OH)₂ was predominantly contained in the transparent layer remaining. Characterization by high resolution SEM confirmed the morphology of the transparent layer was homogenous.

Surprisingly, XRD confirmed the composition and purity of the sample to be 100% Mg(OH)₂ (see FIG. 6, which illustrates XRD patterns of the precipitate formed using seawater with the laminar co-flow method, compared to the bulk mixing method of Comparative Example 1). Without being bound by theory, obtaining phase-pure Mg(OH)₂ by LCM was surprising at least because mineral purity is typically associated with synthesis at very low supersaturations and in stirred environments (i.e., close to equilibrium conditions, rather than far-from-equilibrium).

In contrast, one would expect from a basic speciation model that mixing NaOH with seawater at the given concentrations would render multiple minerals in the supersaturation regime, including carbonates such as dolomite, magnesite, calcite, and aragonite, in addition to Mg(OH)₂. Specifically, at the interface of NaOH and seawater, key chemical processes include the reaction of NaOH with Mg²⁺ to form Mg(OH)₂ and with HCO³⁻ to form CO₃²⁻. Subsequently, CO₃²⁻ is able to react with Ca²⁺ in seawater forming CaCO₃. The equilibrium constants for these reactions are 5.6×10⁻¹², and 4.733 10⁻¹¹, and 3.4×10⁻⁹, respectively. Comparative Example 1 provides an example of this expected mixture of minerals that would be expected form in a precipitate, using BMM.

Yet, unexpectedly, the LCM method of Example 1 produced a phase-pure Mg(OH)₂ precipitate.

### Comparative Example 2: Precipitation of Mg(OH)₂ From Natural Seawater by BMM

Mg(OH)₂ was precipitated from natural seawater according to the BMM described for Comparative Example 1 above. The precipitate from the natural seawater contained 67.6% Mg(OH)₂, and 32.4% CaCO₃ as an impurity.

Thus, surprisingly, CaCO₃ impurity was higher relative to that collected from the synthetic seawater sample in Comparative Example 1. Without being bound by theory, it is believed that the increased CaCO₃ in the precipitate may be attributed to a higher concentration of dissolved CO₂, and an increased supersaturation of carbonate minerals relative to hydroxide minerals. It was also observed that the precipitate contained a higher level of the aragonite CaCO₃ polymorph (7.3%) relative to the more stable calcite CaCO₃ polymorph (25.1%). Again, without being bound by theory, it is believed that the increased amount of the less stable polymorph was due to the inclusion of Mg²⁺ ions in the crystal lattice structure.

### EXAMPLE 2: Precipitation of Mg(OH)₂ From Natural Seawater by LCM

Example 2 was conducted to examine whether LCM methodology was able to precipitate highly pure minerals of interest (e.g., Mg(OH)₂) from a more complex mixture of salts. Natural seawater was flowed alongside 0.1 M NaOH as the reactant solution according to the procedure of Example 1 above. After 2 hours, the precipitate that formed at the liquid interface between the flows was collected, washed, and dried.

Surprisingly, the increased dissolved CO₂ in natural seawater did not reduce the purity of the 100% Mg(OH)₂ precipitate formed by the LCM of Example _{2.}

### Comparative Examples 3-6: Precipitation of Mg(OH)₂ From Natural Seawater by LCM/BMM Using Na₂CO₃

Comparative examples 3-6 were conducted to examine whether the pure Mg(OH)₂ obtained by LCM, is due to more than just the limited supply of OH⁻. The reduced contact with air (CO₂) in LCM may also influence or inhibit the formation of CaCO₃. To further investigate the influence of carbonate species, NaOH was replaced by Na₂CO₃ as the reactant. Both low (0.05 M) and high (0.5 M) concentrations of Na₂CO₃ were used in the examples.

Both concentrations of Na₂CO₃ showed the co-precipitation of Mg²⁺ and Ca²⁺, which confirms that the presence of CO₃²⁻ impacts the phase purity of the precipitate. Specifically, the precipitate products form by LCM using Na₂CO₃ as the reactant were distinct from those formed using NaOH as the reactant. For example, the thickness, compactness, and homogeneity of the precipitates.

Our results suggest that a combination of the OH⁻-selective porous precipitate wall and the limited contact with ambient CO₂ in LCM is responsible for the precipitation of phase-pure Mg(OH)₂ from seawater, using NaOH.

### EXAMPLES 3-9: LCM Process Parameters

The relationship of reactant solution concentration in precipitate yield and purity was examined in Examples 3-10 across concentrations of 0.01 M to 2.0 M NaOH, under the general LCM procedure described above for a duration of 1 hour. As shown in Table 3 below, the amount of precipitate formed during the process generally increased with [OH⁻] concentration of the reactant solution reaching a plateau near 3 mg in the range of 0.5 M to 2.0 M. Surprisingly, the purity of each sample as the yield increased remained high, and even the maximally yielding Example 8 demonstrated a purity above 95%.

TABLE 3
Summary of Precipitate Formed During the Process

| | Seawater | | | Precipitate | Mg(OH)₂ | CaCO₃ |
|---|---|---|---|---|---|---|
| Ex. | source | [NaOH] | Time | yield (mg) | (wt. %) | (wt. %) |
| 3 | Synthetic | 0.01M | 1 h | <1 | n.d. | n.d. |
| 4 | Synthetic | 0.05M | 1 h | <1 | n.d. | n.d. |
| 5 | Synthetic | 0.1M | 1 h | 1.26 ± 0.46 | 100 | 0 |
| 6 | Synthetic | 0.2M | 1 h | 2.29 ± 0.30 | 98.8 | 1.2 |
| 7 | Synthetic | 0.5M | 1 h | 2.78 ± 0.36 | 96.1 | 3.9 |
| 8 | Synthetic | 1.0M | 1 h | 3.15 ± 0.27 | 97.9 | 2.4 |
| 9 | Synthetic | 2.0M | 1 h | 3.01 ± 0.16 | 93.5 | 6.5 |

### ASPECTS

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1: A laminar co-flow method for chemical extraction, the method comprising: flowing a mineral source solution through a first flow path of a flow cell chamber; flowing a reactant solution through a second flow path of the flow cell chamber; contacting the mineral source solution and the reactant solution along a flow path interface to form a mineral precipitate at the flow path interface; wherein the mineral precipitate comprises a cation from the mineral source solution and an anion from the reactant solution.

Aspect 2: The method of aspect 1, wherein a flow within the flow cell chamber is a laminar flow characterized by a Reynolds number of less than 2,500.

Aspect 3: The method of aspect 1, wherein the flow cell chamber has a volume in a range from 0.01 mL to 10 L, the flow path interface has a width in a range from about 0.1 mm to 10 cm, the mineral source solution has a flow rate in a range from 0.1 mL/h to 100 mL/h, and the reactant solution has a flow rate in a range from 0.1 mL/h to 100 mL/h. The flow rate will be dictated by the pipe size, and it should be understood that the flow rate could be much larger, if industrial scale pipes are used.

Aspect 4: The method of aspect 1, wherein the width of the flow path interface is less than 10% that of a widest cross-sectional length of the flow cell chamber.

Aspect 5: The method of aspect 1, wherein the flow path interface comprises a concentration gradient of the mineral varying from first concentration in the mineral source solution to a second concentration in the reactant solution, the first concentration being greater than the second concentration.

Aspect 6: The method of aspect 1, wherein the mineral source solution is seawater, a mined material dispersion, recycled source, or a geothermal brine.

Aspect 7: The method of aspect 1, wherein the mineral source solution comprises an alkali metal salt, an alkaline earth metal salt, a transition metal salt, a post-transition metal salt, or any combination thereof.

Aspect 8: The method of aspect 1, wherein a concentration of the cation or anion in the mineral source solution is in a range from about 0.1 g/L to about 10 g/L.

Aspect 9: The method of aspect 1, wherein the reactant source solution comprises a halide anion, a hydroxide anion, a sulfate anion, a carbonate anion, a nitrate anion, a nitrite anion, a phosphate anion, or combinations thereof.

Aspect 10: The method of aspect 1, wherein the reactant source solution is aqueous NaOH with a OH⁻ concentration in a range from 0.01 M to 1 M.

Aspect 11: The method of aspect 1, wherein the reactant source solution has a pH at least 2.0 greater than a pH of the mineral source solution.

Aspect 12: The method of aspect 1, wherein a ratio of the flow rate of the mineral source solution to a flow rate of the reactant solution is in a range from 2:1 to 1:2.

Aspect 13: The method of aspect 1, further comprising recycling an outflow of the mineral source solution.

Aspect 14: The method of aspect 1 further comprising extracting the mineral precipitate from the flow cell chamber.

Aspect 15: The method of aspect 1, wherein the mineral precipitate comprises a sodium cation, a magnesium cation, a calcium cation, a barium cation, a potassium cation, an ammonium cation, an iron cation, a copper cation, a zinc cation, a lead cation, a silver cation, an aluminum cation, a mercury cation, antimony, arsenic, barite, beryllium, bismuth, cesium, chromium, cobalt, fluorspar, gallium, germanium, graphite, hafnium, helium, indium, lithium, magnesium, manganese, niobium, platinum group metals, potash, rhenium, rubidium, scandium, strontium, tantalum, tellurium, tin, titanium, tungsten, uranium, vanadium, or zirconium.

Aspect 16: The method of aspect 10, wherein the mineral precipitate comprises magnesium carbonate, magnesium hydroxide, magnesium phosphate, calcium carbonate, calcium phosphate, or calcium sulfate.

Aspect 17: The method of aspect 1, wherein the mineral precipitate has a purity of greater than 95%.

Aspect 18: The method of aspect 17, wherein the mineral precipitate is formed in from about 2 hours to about 4 hours.

Aspect 19: A sheet of high-purity material, formed by the process of contacting a reactant solution with a mineral source solution, the reactant solution being flown down a first flow path of a flow cell chamber, and the mineral source solution being flown down a second flow path of the flow sell chamber in a laminar co-flow environment.

Aspect 20: The sheet of high-purity material of aspect 19, wherein the reactant solution is NaOH and the mineral source solution is seawater, and the sheet of high-purity material comprises a magnesium cation, a sodium cation, a calcium cation, a barium cation, a potassium cation, a ammonium cation, an iron cation, a copper cation, a zinc cation, a lead cation, a silver cation, an aluminum cation, a mercury cation, magnesium carbonate, magnesium hydroxide, magnesium phosphate, calcium carbonate, calcium phosphate, or calcium sulfate.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A laminar co-flow method for chemical extraction, the method comprising:
flowing a mineral source solution through a first flow path of a flow cell chamber;
flowing a reactant solution through a second flow path of the flow cell chamber;
contacting the mineral source solution and the reactant solution along a flow path interface to form a mineral precipitate at the flow path interface;
wherein the mineral precipitate comprises a cation from the mineral source solution and an anion from the reactant solution.

2. The method of claim 1, wherein a flow within the flow cell chamber is a laminar flow characterized by a Reynolds number of less than 2,500.

3. The method of claim 2, wherein the flow cell chamber has a volume in a range from 0.01 mL to 10 L, the flow path interface has a width in a range from about 0.1 mm to 10 cm, the mineral source solution has a flow rate in a range from 0.1 mL/h to 100 mL/h, and the reactant solution has a flow rate in a range from 0.1 mL/h to 100 mL/h.

4. The method of claim 1, wherein the width of the flow path interface is less than 10% that of a widest cross-sectional length of the flow cell chamber.

5. The method of claim 1, wherein the flow path interface comprises a concentration gradient of the mineral varying from first concentration in the mineral source solution to a second concentration in the reactant solution, the first concentration being greater than the second concentration.

6. The method of claim 1, wherein the mineral source solution is seawater, a mined material dispersion, a recycling stream, industrial waste, or a geothermal brine.

7. The method of claim 1, wherein the mineral source solution comprises an alkali metal salt, an alkaline earth metal salt, a transition metal salt, rare earth element, a post-transition metal salt, or any combination thereof.

8. The method of claim 1, wherein a concentration of the cation in the mineral source solution is in a range from about 0.1 g/L to about 10 g/L.

9. The method of claim 1, wherein the reactant source solution comprises a halide anion, a hydroxide anion, a sulfate anion, a carbonate anion, a nitrate anion, a nitrite anion, a phosphate anion, or any organic anions combinations thereof.

10. The method of claim 1, wherein the reactant source solution is aqueous NaOH with a OH⁻ concentration in a range from 0.01 M to 1 M.

11. The method of claim 1, wherein the reactant source solution has a pH difference of 2.0 greater than a pH of the mineral source solution.

12. The method of claim 1, wherein a ratio of the flow rate of the mineral source solution to a flow rate of the reactant solution is in a range from 2:1 to 1:2.

13. The method of claim 1, further comprising recycling an outflow of the mineral source solution.

14. The method of claim 1, further comprising extracting the mineral precipitate from the flow cell chamber.

15. The method of claim 1, wherein the mineral precipitate comprises a sodium cation, a magnesium cation, a calcium cation, a barium cation, a potassium cation, an ammonium cation, an iron cation, a copper cation, a zinc cation, a lead cation, a silver cation, an aluminum cation, a mercury cation, antimony, arsenic, barite, beryllium, bismuth, cesium, chromium, cobalt, fluorspar, gallium, germanium, graphite, hafnium, helium, indium, lithium, magnesium, manganese, niobium, platinum group metals, potash, rhenium, rubidium, scandium, strontium, tantalum, tellurium, tin, titanium, tungsten, uranium, vanadium, or zirconium.

16. The method of claim 10, wherein the mineral precipitate comprises magnesium carbonate, magnesium hydroxide, magnesium phosphate, calcium carbonate, calcium phosphate, or calcium sulfate.

17. The method of claim 1, wherein the mineral precipitate has a purity of greater than 95%.

18. The method of claim 17, wherein the mineral precipitate is formed in from about 2 hours to about 4 hours.

19. A sheet of high-purity material, formed by the process of contacting a reactant solution with a mineral source solution, the reactant solution being flown down a first flow path of a flow cell chamber, and the mineral source solution being flown down a second flow path of the flow sell chamber in a laminar co-flow environment.

20. The sheet of high-purity material of claim 19, wherein the reactant solution is NaOH and the mineral source solution is seawater, and the sheet of high-purity material comprises a magnesium cation, a sodium cation, a calcium cation, a barium cation, a potassium cation, a ammonium cation, an iron cation, a copper cation, a zinc cation, a lead cation, a silver cation, an aluminum cation, a mercury cation, magnesium carbonate, magnesium hydroxide, magnesium phosphate, calcium carbonate, calcium phosphate, or calcium sulfate.
